(19) United States
(12) Patent Application Publication
(10) Pub. No.: US 2019/0144003 A1
(43) Pub. Date: May 16, 2019

(54) DISTRACTED DRIVING DETERMINATION APPARATUS, DISTRACTED DRIVING DETERMINATION METHOD, AND PROGRAM

(71) Applicant: OMRON Corporation, Kyoto-shi (JP)

(72) Inventors: Tadashi HYUGA, Hirakata-shi (JP); Tomoyoshi AIZAWA, Kyoto-shi (JP); Hatsumi AOI, Kyotanabe-shi (JP); Yoshio MATSUURA, Kasugai-shi (JP); Masato TANAKA, Kizugawa-shi (JP); Keisuke YOKOTA, Kasugai-shi (JP); Hisashi SAITO, Kasugai-shi (JP)

(73) Assignee: OMRON Corporation, Kyoto-shi (JP)

(21) Appl. No.: 16/145,044

(22) Filed: Sep. 27, 2018

(30) Foreign Application Priority Data
Nov. 15, 2017 (JP) 2017-219855

(51) Int. Cl. B60W 50/14; B60W 40/08; G06K 9/00; G06F 3/01; B60W 30/18

(52) U.S. Cl. CPC B60W 50/14; B60W 40/08; G06K 9/00845; B60W 2050/143; B60W 30/18154; B60W 2040/0818; G06F 3/013

(57) ABSTRACT

To alert a driver looking in one direction for a relatively long time when changing the vehicle traveling direction, an apparatus includes a data obtaining unit, which obtains sensing data, a gaze direction detector, which detects a driver gaze direction, a gaze direction determiner, which determines distracted driving based on whether the gaze direction deviates by at least a predetermined angle from a traveling direction, and the deviation continues for at least a predetermined allowable duration allowing distracted driving, an alert controller, which outputs a signal instructing to generate an alert, a traveling direction determiner, which detects a change in the traveling direction, and a duration changer, which shortens the allowable duration in response to an intersection being recognized and a change detected in the traveling direction.

### CROSS-REFERENCE TO RELATED APPLICATION

This application claims priority to Japanese Patent Application No. 2017-219855 filed on Nov. 15, 2017, the entire disclosure of which is incorporated herein by reference.

### FIELD

The present invention relates to a distracted driving determination apparatus, a distracted driving determination method, and a program for determining distracted driving of a vehicle driver.

### BACKGROUND

A known alert device mounted on a vehicle determines distracted driving of a driver based on his or her face orientation or gaze using an image of the driver captured during driving with, for example, an on-board camera, and alerts the driver in a timely manner.

This type of alert device determines distracted driving of a driver based on a predetermined criterion. For example, Patent Literature 1 (Japanese Unexamined Patent Application Publication No. 2001-138767) uses, as one such criterion, an allowable duration that is changeable depending on the driving state.

The allowable duration in Patent Literature 1 refers to a duration for which distracted driving causes no alert, or in other words, a duration for which distracted driving is allowed.

The allowable duration is set shorter when, for example, the vehicle is traveling at a speed higher than a predetermined speed or at a distance shorter than a predetermined distance from a vehicle traveling immediately ahead. The allowable duration is set longer when the vehicle is traveling at a speed lower than a predetermined speed or at a distance longer than a predetermined distance from a vehicle traveling immediately ahead.

### SUMMARY

### Technical Problem

However, such known alert devices may have issues described below.

For example, a driver intending to turn left at an intersection may more carefully check the surroundings than during usual driving for an object such as a motorcycle approaching from the left rear.

In this case, the alert device may desirably alert the driver looking in one specific direction for a long time to direct his or her gaze in other directions to check the surroundings more carefully than during usual driving.

However, the above alert device described in, for example, Patent Literature 1 uses a longer allowable duration set for a vehicle traveling at a speed lower than a predetermined speed or at a distance longer than a predetermined distance from the vehicle traveling immediately ahead.

The allowable duration is thus set longer when, for example, a vehicle with no preceding vehicle enters an intersection and turns right or left at a speed lower than a predetermined speed. The above alert device cannot alert the driver looking in one specific direction for a relatively long time without carefully checking the surroundings before the driver changes the traveling direction of the vehicle by turning right or left at the intersection. The alert device thus cannot alert the driver to check the surroundings.

One or more aspects of the present invention are directed to a distracted driving determination apparatus, a distracted driving determination method, and a program for controlling an alert device that alerts a vehicle driver to check the surroundings when the driver changes the vehicle traveling direction to right or left at an intersection.

### Solution to Problem

In response to the above issue, the aspects of the present invention may be implemented in the manner described below.

A distracted driving determination apparatus according to a first aspect of the present invention includes a data obtaining unit that obtains sensing data from a sensor included in a vehicle, a gaze direction detector that detects a gaze direction of a driver of the vehicle based on the obtained sensing data, a gaze direction determiner that detects distracted driving based on whether the detected gaze direction deviates by at least a predetermined angle from a traveling direction of the vehicle, and whether the deviation continues for at least a predetermined allowable duration allowing distracted driving, an alert controller that outputs a signal instructing to generate an alert in response to distracted driving detected by the gaze direction determiner, an intersection recognizer that recognizes an intersection in front of the vehicle in the traveling direction based on the obtained sensing data, a traveling direction determiner that detects a change in the traveling direction of the vehicle based on the obtained sensing data, and a duration changer that shortens the allowable duration in response to an intersection being recognized and a change detected in the traveling direction.

A distracted driving determination apparatus according to a second aspect of the present invention is the distracted driving determination apparatus according to the first aspect including the duration changer including a first changer that changes the allowable duration in accordance with a speed of the vehicle or a distance between the vehicle and a preceding vehicle determined using the obtained sensing data, and a second changer that shortens, in response to an intersection being recognized and a change detected in the traveling direction, the allowable duration to a duration shorter than the allowable duration yet to be changed by the first changer.

A distracted driving determination apparatus according to a third aspect of the present invention is the distracted driving determination apparatus according to the second aspect including the first changer using, as the sensing data, speed information from a speed sensor included in the vehicle, and image information about the preceding vehicle captured by an exterior view camera included in the vehicle, comparing the speed of the vehicle determined from the speed information with a predetermined speed, and comparing the distance between the vehicle and the preceding vehicle determined from the image information with a predetermined distance.

A distracted driving determination apparatus according to a fourth aspect of the present invention is the distracted driving determination apparatus according to the first aspect including the duration changer including a restorer that changes, in response to the intersection being no longer recognized or the change being no longer detected in the traveling direction, the shortened allowable duration back to the allowable duration yet to be shortened.

A distracted driving determination apparatus according to a fifth aspect of the present invention is the distracted driving determination apparatus according to the first aspect including the gaze direction deviating by at least the predetermined angle within one of a plurality of determinant areas defined for detecting distracted driving, and the allowable duration separately set for each of the plurality of determinant areas.

A distracted driving determination apparatus according to a sixth aspect of the present invention is the distracted driving determination apparatus according to the first aspect including the intersection recognizer that recognizes the intersection based on prestored map information in addition to the sensing data.

A distracted driving determination apparatus according to a seventh aspect of the present invention is the distracted driving determination apparatus according to the first aspect including the traveling direction determiner that detects the change in the traveling direction based on prestored map information in addition to the sensing data.

A distracted driving determination apparatus according to an eighth aspect of the present invention is the distracted driving determination apparatus according to the first aspect including the traveling direction determiner that detects the change in the traveling direction in response to detection of the vehicle entering a right-turn lane or a left-turn lane of a road based on prestored map information in addition to the sensing data.

A distracted driving determination method according to a ninth aspect of the present invention is performed by a distracted driving determination apparatus. The method includes obtaining, with the distracted driving determination apparatus, sensing data from a sensor included in a vehicle, detecting, with the distracted driving determination apparatus, a gaze direction of a driver of the vehicle based on the obtained sensing data, detecting, with the distracted driving determination apparatus, distracted driving based on whether the detected gaze direction deviates by at least a predetermined angle from a traveling direction of the vehicle, and the deviation continues for at least a predetermined allowable duration allowing distracted driving, outputting, with the distracted driving determination apparatus, a signal instructing to generate an alert in response to detected distracted driving, recognizing, with the distracted driving determination apparatus, an intersection in front of the vehicle in the traveling direction based on the obtained sensing data, detecting, with the distracted driving determination apparatus, a change in the traveling direction of the vehicle based on the obtained sensing data, and shortening, with the distracted driving determination apparatus, the allowable duration in response to the intersection being recognized and the change detected in the traveling direction.

A program according to a tenth aspect of the present invention for determining distracted driving causes a computer to implement processes performed by the units included in the distracted driving determination apparatus according to any one of the first to eighth aspects.

### Advantageous Effects

The apparatus, method, and program according to the first, ninth, and tenth aspects of the present invention can recognize an intersection in front of the vehicle in the traveling direction, detect a change in the traveling direction of the vehicle, and shorten an allowable duration preset for allowing distracted driving in response to an intersection being recognized and a change detected in the traveling direction.

The apparatus according to the second aspect changes the allowable duration in accordance with the vehicle speed or the distance between the vehicle and the preceding vehicle. However, the allowable duration once changed can be shortened to a duration shorter than the allowable duration yet to be changed in response to an intersection being recognized and a change detected in the traveling direction.

The apparatus according to the third aspect obtains the vehicle speed using a speed sensor, and compares the speed with a predetermined speed. The apparatus also determines the distance between the vehicle and the preceding vehicle from image information captured by the exterior view camera, and compares the distance with a predetermined distance. The comparison results can be used to determine whether the first changer is to change the allowable duration.

The apparatus according to the fourth aspect changes, in response to the intersection being no longer recognized or the change being no longer detected in the traveling direction, the shortened allowable duration back to the allowable duration yet to be shortened. The apparatus can thus continue distracted driving determination based on an appropriate allowable duration.

The apparatus according to the fifth aspect defines a plurality of determinant areas for detecting distracted driving and separately sets allowable durations for the individual determinant areas. The apparatus can thus more precisely determine distracted driving.

The apparatus according to the sixth aspect highly accurately recognizes an intersection using map information in addition to sensing data.

The apparatus according to the seventh aspect highly accurately detects a change in the traveling direction using map information in addition to sensing data.

The apparatus according to the eighth aspect detects a change in the traveling direction in response to an intention to turn right or left in addition to an actual change in the traveling direction.

### BRIEF DESCRIPTION OF THE DRAWINGS

FIG. 1 is a schematic diagram of a vehicle including a distracted driving determination apparatus implementing a distracted driving determination method according to one or more embodiments of the present invention.

FIG. 2 is a functional block diagram of a distracted driving determination apparatus according to a first embodiment.

FIG. 3 is a schematic diagram describing examples of allowable durations included in a criterion.

FIG. 4 is a schematic diagram describing examples of shortened allowable durations.

FIG. 5 is a flowchart showing an example operation performed by the distracted driving determination apparatus according to the first embodiment.

FIG. 6 is a functional block diagram of a distracted driving determination apparatus according to a second embodiment.

FIG. 7 is a schematic diagram showing examples of extended allowable durations.

FIG. 8 is a flowchart showing an example operation performed by the distracted driving determination apparatus according to the second embodiment.

### DETAILED DESCRIPTION

Embodiments of the present invention will be described below with reference to the drawings.

### Example

### Structure

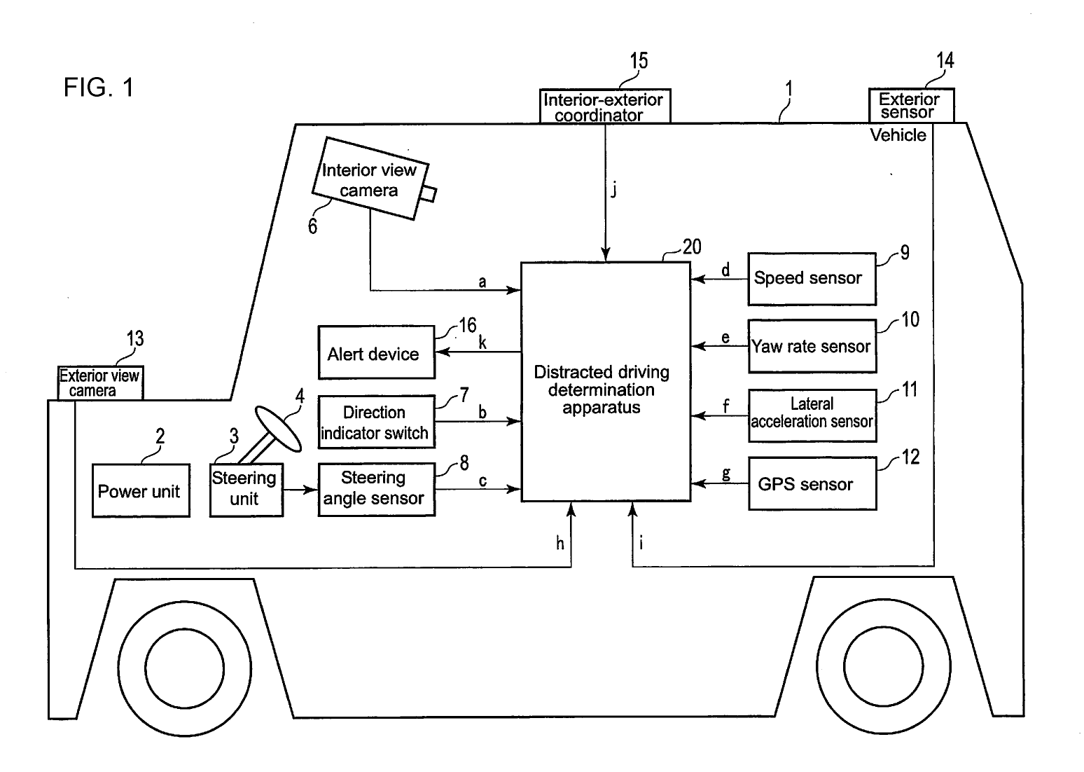

An example of a distracted driving determination apparatus implementing a distracted driving determination method according to one or more embodiments of the present embodiment will now be described with reference to FIG. 1.

FIG. 1 is a schematic diagram of a vehicle including a distracted driving determination apparatus implementing the distracted driving determination method according to one embodiment.

A vehicle 1 typically includes, as its basic components, a power unit 2 including a power supply and a speed changer, and a steering unit 3 incorporating a steering wheel 4. The vehicle 1 further includes a transmission for transmitting power generated by the power unit 2 to the wheels, a controller for controlling driving, and various sensors for controlling the controller. To simplify the drawing, FIG. 1 does not show these components, and simply shows a distracted driving determination apparatus 20 and components associated with the distracted driving determination apparatus 20, including an interior view camera 6, a direction indicator switch 7, a steering angle sensor 8, a speed sensor 9, a yaw rate sensor 10, a lateral acceleration sensor 11, a position measurement sensor, such as a global positioning system (GPS) sensor 12, an exterior view camera 13, an exterior sensor 14, an interior-exterior coordinator 15, and an alert device 16.

The interior view camera 6 is installed in the vehicle interior in front of a driver on, for example, the instrument panel. The interior view camera 6 captures an image of the driver, and outputs an image data signal a to the distracted driving determination apparatus 20. The interior view camera 6 may start capturing images of the driver in response to a request from the distracted driving determination apparatus 20 or may constantly capture such images during the operation of the vehicle 1.

The direction indicator switch 7 outputs, to the distracted driving determination apparatus 20, a direction indicator signal b corresponding to a direction to which the vehicle 1 is redirected to turn right or left or to change the lane.

The steering angle sensor 8 outputs, to the distracted driving determination apparatus 20, a steering angle signal c corresponding to the steering direction, the neutral position, and the steering angle in accordance with the operation of the steering unit 3.

The speed sensor 9 detects the speed of the vehicle 1, and outputs a detection signal d corresponding to the detected speed to the distracted driving determination apparatus 20.

The yaw rate sensor 10 detects the yaw rate of the vehicle 1, and outputs a detection signal e corresponding to the detected yaw rate to the distracted driving determination apparatus 20.

The lateral acceleration sensor 11 detects a lateral acceleration of the vehicle 1, and outputs a detection signal f corresponding to the detected lateral acceleration to the distracted driving determination apparatus 20.

The GPS sensor 12 detects position information for the vehicle 1, and outputs a detection signal g corresponding to the detected position information to the distracted driving determination apparatus 20.

The exterior view camera 13 is installed at the vehicle exterior to capture front images of the vehicle 1, and outputs an image data signal h to the distracted driving determination apparatus 20.

The exterior sensor 14, like an infrared sensor or a radar, is used to recognize the surroundings of the vehicle, and transmits, for example, an external sensing signal i into the vehicle 1. The exterior sensor 14, which may be an infrared sensor or a radar, measures a distance to an object around the vehicle 1, and outputs a sensing signal i corresponding to the distance to the distracted driving determination apparatus 20.

The interior-exterior coordinator 15 receives traffic information transmitted from the Vehicle Information and Communication System (VICS, registered trademark) (not shown) or other information transmitted from other vehicles, and outputs a received signal j to the distracted driving determination apparatus 20.

The distracted driving determination apparatus 20 receives the image data signal a, the direction indicator signal b, the steering angle signal c, the detection signal d, the detection signal e, the detection signal f, the detection signal g, the image data signal h, the sensing signal i, and the received signal j respectively output from the interior view camera 6, the direction indicator switch 7, the steering angle sensor 8, the speed sensor 9, the yaw rate sensor 10, the lateral acceleration sensor 11, the GPS sensor 12, the exterior view camera 13, the exterior sensor 14, and the interior-exterior coordinator 15. The distracted driving determination apparatus 20 then detects the gaze direction of the driver based on the obtained sensing data. The distracted driving determination apparatus 20 also determines whether the detected gaze direction deviates from the traveling direction of the vehicle 1 by at least a predetermined angle. When determining that the gaze direction deviates from the vehicle traveling direction, the distracted driving determination apparatus 20 determines whether the deviation continues for at least a predetermined allowable duration allowing distracted driving. When the deviation continues for at least the allowable duration, the distracted driving determination apparatus 20 detects distracted driving, and outputs a warning instruction signal k to activate the alert device 16.

Based on the sensing data, the distracted driving determination apparatus 20 recognizes an intersection in front of the vehicle 1 in the traveling direction, and determines whether the vehicle 1 is to change the traveling direction. In response to an intersection being recognized and a change detected in the traveling direction, the distracted driving determination apparatus 20 shortens the allowable durations. The distracted driving determination apparatus 20 thus outputs the warning instruction signal k earlier in response to the intersection being recognized and the change detected in the traveling direction of the vehicle 1.

The alert device 16 is installed in the vehicle interior. The alert device 16 includes, for example, a speaker, a display, a light emitting device, or a vibrator to generate an alert in response to the warning instruction signal k from the distracted driving determination apparatus 20. Examples of an alert include a buzzer or chime sound, a voice message, a display message, lighting or blinking of light, and vibrations. Examples of an alert also include an alert generated in response to the warning instruction signal k transmitted to a mobile terminal carried by the driver.

### Advantages and Effects

The distracted driving determination apparatus 20 thus uses shorter allowable durations in response to the vehicle 1 approaching an intersection and changing the traveling direction than in straight traveling. The distracted driving determination apparatus 20 thus can alert a driver earlier than in straight traveling when his or her gaze is directed in only one direction to change the traveling direction. Thus, the distracted driving determination apparatus 20 prompts the driver to thoroughly check the surroundings when changing the traveling direction of the vehicle 1.

### First Embodiment

The distracted driving determination apparatus 20 according to a first embodiment will now be described.

### Example Structure

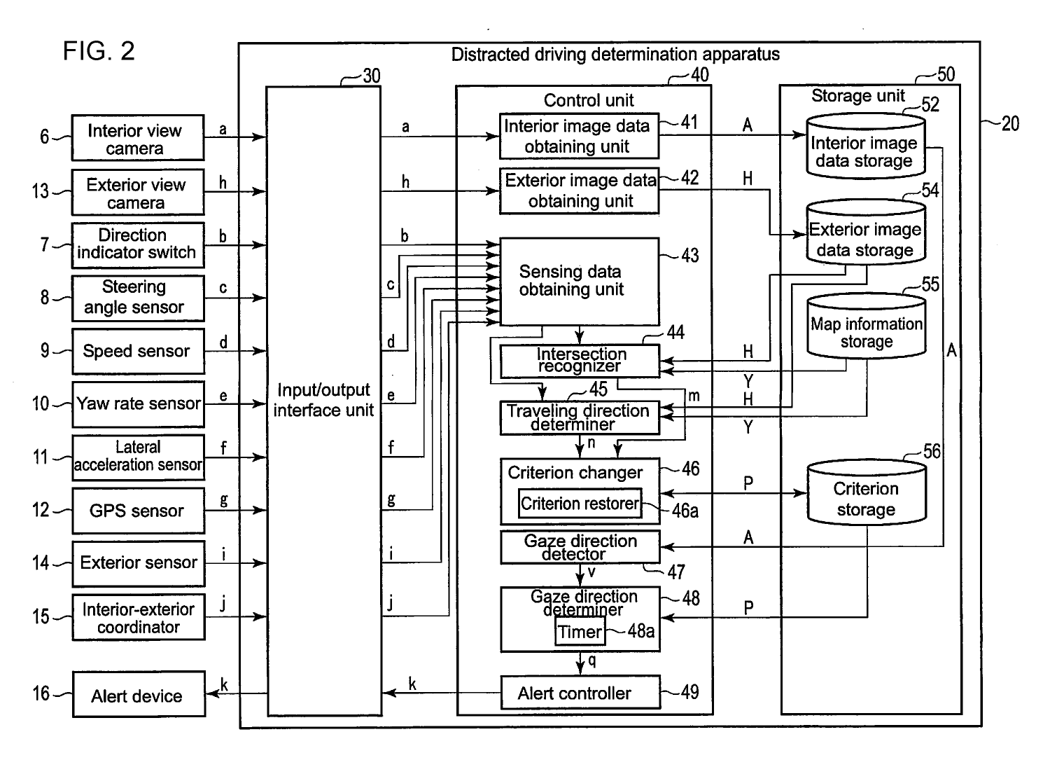

FIG. 2 is a functional block diagram of the distracted driving determination apparatus 20 according to the present embodiment.

The distracted driving determination apparatus 20 includes an input/output interface unit 30, a control unit 40, and a storage unit 50 as its hardware components.

The input/output interface unit 30 receives an image data signal a output from the interior view camera 6, a direction indicator signal b output from the direction indicator switch 7, a steering angle signal c output from the steering angle sensor 8, a detection signal d output from the speed sensor 9, a detection signal e output from the yaw rate sensor 10, a detection signal f output from the lateral acceleration sensor 11, a detection signal g output from the GPS sensor 12, an image data signal h output from the exterior view camera 13, a sensing signal i output from the exterior sensor 14, and a received signal j output from the interior-exterior coordinator 15. The input/output interface unit 30 outputs these signals to the control unit 40. The input/output interface unit 30 also outputs a warning instruction signal k received from the control unit 40 to the alert device 16.

The storage unit 50 uses a nonvolatile memory as a storage medium, such as a solid state drive (SSD) or a hard disk drive (HDD), which is writable and readable as appropriate. The storage unit 50 includes, as storage areas according to the present embodiment, an interior image data storage 52, an exterior image data storage 54, a map information storage 55 prestoring map information Y, and a criterion storage 56 prestoring a criterion P.

The control unit 40 includes a central processing unit (CPU) included in a computer, and a program memory. The control unit 40 includes, as control functions according to the present embodiment, an interior image data obtaining unit 41, an exterior image data obtaining unit 42, a sensing data obtaining unit 43, an intersection recognizer 44, a traveling direction determiner 45, a criterion changer 46, a gaze direction detector 47, a gaze direction determiner 48, and an alert controller 49. These control functions are implemented by the CPU executing a program stored in the program memory.

The interior image data obtaining unit 41 receives image data signals a captured by the interior view camera 6 and output from the input/output interface unit 30, and stores the signals into the interior image data storage 52 as image data A. Thus, the interior image data storage 52 stores the image data A representing the state of the driver.

The exterior image data obtaining unit 42 receives image data signals h captured by the exterior view camera 13 and output from the input/output interface unit 30, and stores the signals into the exterior image data storage 54 as image data H. Thus, the exterior image data storage 54 stores the image data H representing the front state of the vehicle 1.

The gaze direction detector 47 detects the gaze direction of the driver from his or her face orientation and gaze captured in the image data A stored in the interior image data storage 52. The gaze direction detector 47 outputs a detection result v to the gaze direction determiner 48.

The gaze direction determiner 48 determines whether the gaze direction deviates by at least a predetermined angle from the traveling direction W of the vehicle 1. The gaze direction determiner 48 further determines whether the deviation continues for at least the allowable duration to detect distracted driving of the driver based on the gaze direction of the driver obtained from the detection result v, and the criterion P stored in the criterion storage 56. When determining that the gaze direction deviates by at least the predetermined angle from the traveling direction for at least the allowable duration, the gaze direction determiner 48 detects distracted driving, and outputs an activation signal q to the alert controller 49. The gaze direction determiner 48 does not detect distracted driving in any other cases.

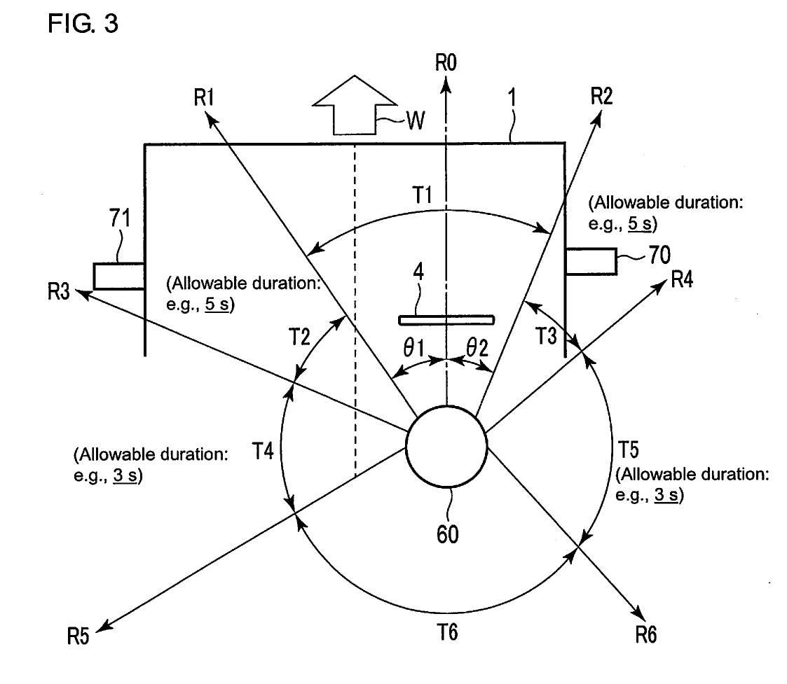

The criterion P and the allowable durations will be described with reference to FIG. 3.

FIG. 3 is a schematic diagram of the vehicle interior viewed from above describing an example of the criterion P for the vehicle 1 traveling straight. FIG. 3 also shows a right side mirror 70 and a left side mirror 71.

When the vehicle 1 is traveling straight (upward in the figure) at a normal speed (e.g., 60 km per hour), the gaze direction R of a driver 60 is parallel to the traveling direction W of the vehicle 1 or points straight ahead in a gaze direction R0.

In this case, the gaze direction R is expected not to deviate leftward from the gaze direction R1 or rightward from the gaze direction R2, although it can slightly move leftward or rightward from the gaze direction R0. The driver 60 having his or her gaze direction R within a spatial area T1 between the gaze directions R1 and R2 is determined not to be in distracted driving. The driver 60 having his or her gaze direction R within the spatial area T6 at the rear of the vehicle is also determined not to be in distracted driving. This is because the driver 60 has his or her gaze directed to the rear of the vehicle 1 for an intended checking action, such as a visual check for the rear. The alert device 16 is thus not activated while the gaze direction R is within the spatial areas T1 and T6. The spatial areas T1 and T6, which are independent of activation of the alert device 16, are referred to as non-determinant areas T1 and T6.

In the example shown in FIG. 3, the vehicle 1 travels on the left side of the road as in Japan. In this example, an angle 81 between the gaze directions R0 and R1 is greater than an angle 82 between the gaze directions R0 and R2. The relationship between these angles is reversed on roads where vehicles travel on the right side as in the U.S.

When the gaze direction R is within any spatial area other than the non-determinant areas T1 and T6, that is, within the spatial area deviating by at least a predetermined angle (leftward angle 81 or rightward angle 82) from the traveling direction W of the vehicle for at least a predetermined duration, the distracted driving determination apparatus 20 detects distracted driving and activates the alert device 16. This spatial area is herein referred to as a determinant area.

The determinant area may not be a single area. In the example shown in FIG. 3, four determinant areas T2 to T5 are defined. The determinant area T2 is on the left of and adjacent to the non-determinant area T1 and between the gaze directions R1 and R3. The determinant area T3 is on the right of and adjacent to the non-determinant area T1 and between the gaze directions R2 and R4. The determinant area T4 is on the left of and adjacent to the non-determinant area T6 and between the gaze directions R5 and R3. The determinant area T5 is on the right of and adjacent to the non-determinant area T6 and between the gaze directions R6 and R4.

In the example shown in FIG. 3, the determinant areas T2 and T3 are asymmetric with respect to the gaze direction R0, and the determinant areas T4 and T5 are asymmetric with respect to the gaze direction R0.

As described above, the driver having his or her gaze direction R within any of the determinant areas T2 to T5 is determined not to be in distracted driving when the driver changes his or her gaze direction R to another determinant area or to the non-determinant area T1 or T6 in less than the predetermined time. Thus, the predetermined time set for each determinant area for such distracted driving determination is herein referred to as an allowable duration. In other words, the allowable duration refers to a duration of time allowed for the gaze direction R of the driver 60 to remain within the same determinant area without causing distractive driving to be detected.

The allowable duration can be set for each determinant area. In the example shown in FIG. 3, the allowable duration is set at five seconds for the determinant area T2, five seconds for the determinant area T3, three seconds for the determinant area T4, and three seconds for the determinant area T5. As described later, the allowable duration is changeable depending on the driving state. In the present embodiment, the allowable duration set for straight traveling at a normal speed is preset as the initial value as shown in FIG. 3.

The gaze direction determiner 48 determines that the driver is not engaging in distracted driving when the gaze direction R is within either the non-determinant area T1 or T6. When the gaze direction R is within any of the determinant areas T2 to T5, the gaze direction determiner 48 activates a built-in timer 48a, which then counts the time for which the gaze direction R remains within the same determinant area. The gaze direction determiner 48 then determines whether the count reaches the allowable duration set for the corresponding determinant area.

When the gaze direction R moves to another determinant area or the non-determinant area T1 or T6 before the count reaches the allowable duration, the gaze direction determiner 48 stops the timer 48a and resets the count.

When the count of the timer 48a reaches the allowable duration of the corresponding one of the determinant areas T2 to T5, the gaze direction determiner 48 detects distracted driving, and outputs the activation signal q to the alert controller 49 to activate the alert device 16.

In response to the activation signal q output from the gaze direction determiner 48, the alert controller 49 outputs the warning instruction signal k to the input/output interface unit 30. The input/output interface unit 30 outputs the warning instruction signal k to the alert device 16.

In response to the warning instruction signal k output from the input/output interface unit 30, the alert device 16 generates an alert. Examples of an alert include, in addition to a buzzer sound, a display, light emission, vibrations, and communication to mobile terminals. The alert device 16 thus generates an alert to the distracted driver 60.

As described below, the distracted driving determination apparatus 20 activates the alert device 16 earlier when the vehicle 1 changes the traveling direction at the intersection by turning right or left than in straight traveling.

To enable the activation, the sensing data obtaining unit 43 receives the direction indicator signal b, the steering angle signal c, the detection signal d, the detection signal e, the detection signal f, the detection signal g, the sensing signal i, and the received signal j output from the input/output interface unit 30, and outputs these signals to the intersection recognizer 44 and the traveling direction determiner 45. Thus, the intersection recognizer 44 and the traveling direction determiner 45 obtain direction indicator information B from the direction indicator signal b, steering angle information C from the steering angle signal c, speed information D from the detection signal d, yaw rate information E from the detection signal e, lateral acceleration information F from the detection signal f, position information G from the detection signal g, distance information I from the sensing signal i, and traffic and other information J from the received signal j.

In response to an intersection being recognized in front of the vehicle 1 in the traveling direction based on at least the position information G, the intersection recognizer 44 outputs an intersection recognition signal m to the criterion changer 46.

In addition to the position information G, the intersection recognizer 44 may appropriately use any of the traffic and other information J, the image data H stored in the exterior image data storage 54, and the map information Y stored in the map information storage 55 to recognize an intersection more accurately.

The traveling direction determiner 45 detects a change in the traveling direction of the vehicle 1 by turning right or left based on at least one of the direction indicator information B, the steering angle information C, the yaw rate information E, and the lateral acceleration information F.

The traveling direction determiner 45 detects a change in the traveling direction based on at least the position information G in response to detection of the vehicle 1 entering a right-turn lane or left-turn lane of the road, in addition to detection of the vehicle 1 turning right or left. In addition to the position information G, the traveling direction determiner 45 may appropriately use any of the map information Y stored in the map information storage 55, the traffic and other information J, and the image data H stored in the exterior image data storage 54 to detect a change in the traveling direction more accurately.

In response to the change detected in the traveling direction of the vehicle 1, the traveling direction determiner 45 outputs a detection signal n to the criterion changer 46.

In response to the intersection recognition signal m output from the intersection recognizer 44 and the detection signal n output from the traveling direction determiner 45, the criterion changer 46 obtains the criterion P from the criterion storage 56, changes the criterion P, and returns the changed criterion P to the criterion storage 56. Thus, the criterion changer 46 updates the criterion P stored in the criterion storage 56.

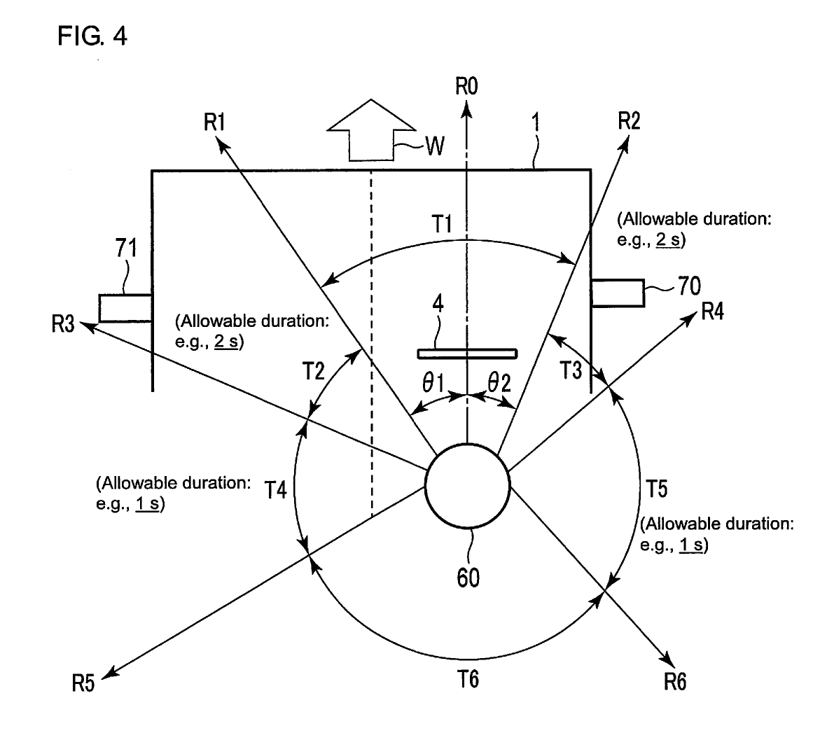

Changing the criterion P includes shortening the allowable durations from the initial values shown in FIG. 3. This will be described with reference to FIG. 4.

FIG. 4 is a schematic diagram of the vehicle interior viewed from above as in FIG. 3, describing the allowable durations shortened from the initial values.

In FIG. 4, the non-determinant areas T1 and T6 and the determinant areas T2 to T5 are defined similarly as in FIG. 3, but the allowable durations set for the determinant areas T2 to T5 are shorter than the allowable durations set for the determinant areas T2 to T5 in FIG. 3. More specifically, the allowable durations for the determinant areas T2 and T3 are shortened from five seconds to two seconds, and the allowable durations for the determinant areas T4 and T5 are shortened from three seconds to one second.

Shortening the allowable durations in this manner changes the criterion P stored in the criterion storage 56. Under the changed criterion P, the gaze direction determiner 48 determines that the driver is not engaging in distracted driving when the gaze direction R is within either the non-determinant area T1 or T6, similarly as in straight travelling. When the gaze direction R is within any of the determinant areas T2 to T5, the gaze direction determiner 48 activates the timer 48a to count the time for which the gaze direction R remains within the same determinant area, and determines whether the count reaches the allowable duration set for the corresponding one of the determinant areas T2 to T5.

When the gaze direction R moves to another determinant area or the non-determinant area T1 or T6 before the count reaches the allowable duration, the gaze direction determiner 48 stops the timer 48a and resets the count.

When the count of the timer 48a reaches the allowable duration of the corresponding determinant area, the gaze direction determiner 48 outputs the activation signal q to the alert controller 49 to activate the alert device 16.

In response to the activation signal q output from the gaze direction determiner 48, the alert controller 49 outputs the warning instruction signal k to the input/output interface unit 30. The input/output interface unit 30 outputs the warning instruction signal k to the alert device 16.

In response to the warning instruction signal k output from the input/output interface unit 30, the alert device 16 generates an alert. Examples of an alert include, in addition to a buzzer sound, a display, light emission, vibrations, and communication to mobile terminals.

As described above, the allowable durations are shortened in response to a change detected in the traveling direction. Thus, the alert device 16 alerts the driver 60 earlier when the driver is gazing in only one direction and prompts the driver 60 to thoroughly check the surroundings when changing the traveling direction of the vehicle 1 at an intersection.

In response to a change detected in the traveling direction, the distracted driving determination apparatus 20 can use the alert device 16 to alert the driver 60 to certainly redirect his or her gaze direction R to the determinant areas T4 and T5 to avoid, for example, hitting a motorcycle when turning, or to prompt the driver to thoroughly check the surroundings.

The criterion changer 46 also includes a criterion restorer 46a. After the gaze direction determiner 48 ends the determination process, the criterion restorer 46a changes the changed allowable durations shown in FIG. 4 back to the initial values shown in FIG. 3.

### Operation

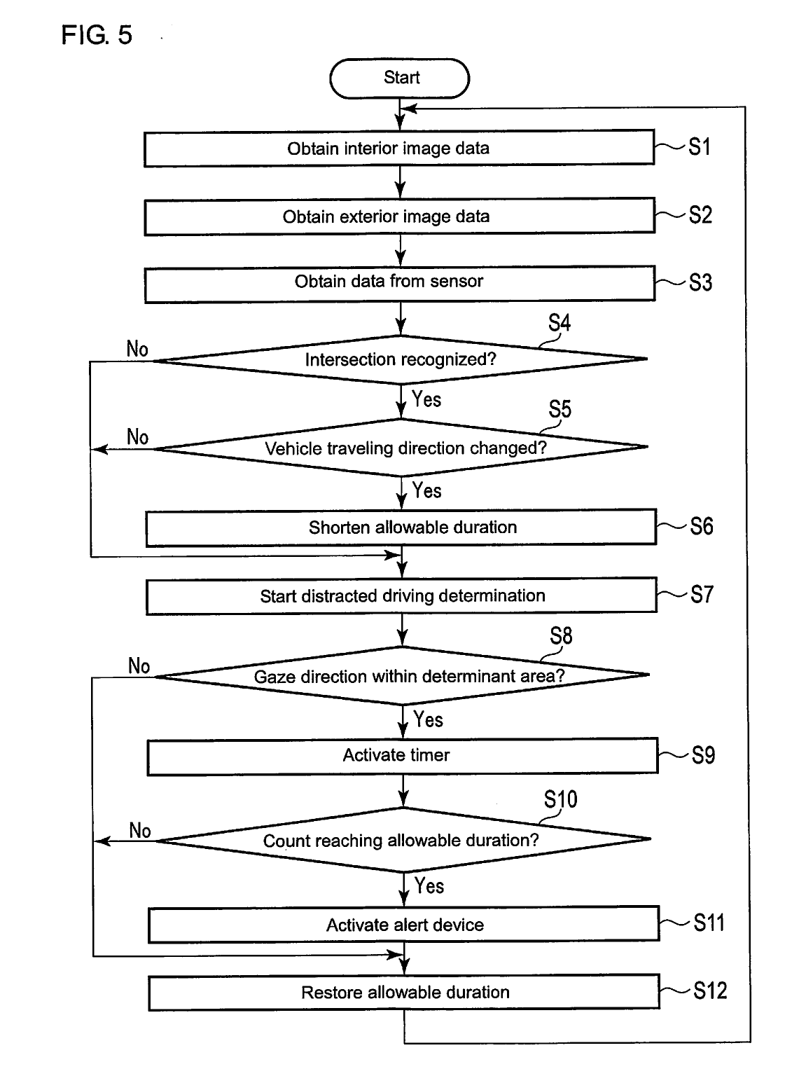

An example operation of the distracted driving determination apparatus 20 with the above structure according to the present embodiment will now be described with reference to the flowchart in FIG. 5.

The interior view camera 6 installed in the vehicle interior outputs the image data signal a corresponding to the state of the driver 60 to the distracted driving determination apparatus 20. The image data signal a is obtained by the interior image data obtaining unit 41 through the input/output interface unit 30, output by the interior image data obtaining unit 41, and stored in the interior image data storage 52 as image data A (S1).

The exterior view camera 13 installed at the vehicle exterior outputs the image data signal h corresponding to the captured front image of the vehicle 1 to the distracted driving determination apparatus 20. The image data signal h is obtained by the exterior image data obtaining unit 42 through the input/output interface unit 30, output by the exterior image data obtaining unit 42, and stored in the exterior image data storage 54 as image data H (S2).

Further, the signals corresponding to the results detected by the direction indicator switch 7, the steering angle sensor 8, the speed sensor 9, the yaw rate sensor 10, the lateral acceleration sensor 11, the GPS sensor 12, and the exterior sensor 14, and the received signal received by the interior-exterior coordinator 15 are also output to the distracted driving determination apparatus 20. These signals are collected by the sensing data obtaining unit 43 through the input/output interface unit 30 (S3).

In this manner, the sensing data obtaining unit 43 obtains the direction indicator information B from the direction indicator signal b, the steering angle information C from the steering angle signal c, the speed information D from the detection signal d, the yaw rate information E from the detection signal e, the lateral acceleration information F from the detection signal f, the position information G from the detection signal g, the distance information I from the sensing signal i, and the traffic and other information J from the received signal j.

The flowchart in FIG. 5 includes steps S1 to S3 as separate steps, but these steps are actually performed in parallel.

For an intersection in front of the vehicle 1 in the traveling direction (Yes in S4), the intersection recognizer 44 recognizes the intersection based on at least the position information G. In addition to the position information G, the intersection recognizer 44 may appropriately use any of the traffic and other information J, the image data H stored in the exterior image data storage 54, and the map information Y stored in the map information storage 55 to recognize the intersection more accurately. In response to the intersection being recognized, the intersection recognizer 44 outputs the intersection recognition signal m to the criterion changer 46. The processing advances to step S5 (described later).

With no intersection in front of the vehicle 1 in the traveling direction (No in S4), the intersection recognizer 44 does not recognize any intersection. The processing then advances to step S7 (described later).

In step S5, the traveling direction determiner 45 determines whether the traveling direction of the vehicle 1 has been changed (S5). The traveling direction determiner 45 detects a change in the traveling direction of the vehicle 1 in response to detection of the vehicle 1 entering a right-turn lane or left-turn lane of the road, in addition to detection of the vehicle 1 turning right or left.

The traveling direction determiner 45 detects the vehicle 1 turning right or left based on at least one of the direction indicator information B, the steering angle information C, the yaw rate information E, and the lateral acceleration information F. The traveling direction determiner 45 also detects the vehicle 1 entering the right-turn lane or left-turn lane of the road based on at least the position information G. In addition to the position information G, the traveling direction determiner 45 may appropriately use any of the map information Y, the traffic and other information J, and the image data H to detect the vehicle 1 entering the lane more accurately.

In response to a change detected in the traveling direction of the vehicle 1 (Yes in S5), the traveling direction determiner 45 outputs a detection signal n to the criterion changer 46.

In response to the intersection recognition signal m output from the intersection recognizer 44 (Yes in S4) and the detection signal n output from the traveling direction determiner 45 (Yes in S5), the criterion changer 46 obtains the criterion P from the criterion storage 56 to shorten the allowable durations (S6).

When the traveling direction determiner 45 detects no change in the traveling direction of the vehicle 1 in step S5 (No in S5), the processing advances to step S7 (described later).

As shown in FIGS. 3 and 4, shortening of the allowable durations includes changing the allowable durations set for the determinant areas T2 to T5 to smaller values. The criterion P stored in the criterion storage 56 is thus updated.

In step S7, the gaze direction detector 47 detects the gaze direction of the driver based on his or her face orientation and gaze in the image captured as the image data A stored in the interior image data storage 52, and outputs the detection result v to the gaze direction determiner 48. Subsequently, the gaze direction determiner 48 starts distracted driving determination based on the gaze direction of the driver determined using the detection result v, and the criterion P stored in the criterion storage 56 (S7).

More specifically, the gaze direction determiner 48 determines that the driver is not engaging in distracted driving when the gaze direction R based on the detection result v is within the non-determinant area T1 or T6 (No in S8). The processing advances to step S12 (described later).

When the gaze direction R is within any of the determinant areas T2 to T5 (Yes in S8), the gaze direction determiner 48 activates the timer 48a (S9) to count the time for which the gaze direction R remains within the same determinant area, and determines whether the count reaches the allowable duration set for the corresponding determinant area (S10).

When the gaze direction R moves to another determinant area or the non-determinant area T1 or T6 before the count reaches the allowable duration (No in S10), the gaze direction determiner 48 stops the timer 48a and resets the count. The processing then advances to step S12 (described later).

When the count of the timer 48a reaches the allowable duration (Yes in S10), the gaze direction determiner 48 outputs the activation signal q to the alert controller 49.

In response to the activation signal q, the alert controller 49 outputs a warning instruction signal k to the input/output interface unit 30. The input/output interface unit 30 then outputs the warning instruction signal k to the alert device 16.

In response to the warning instruction signal k, the alert device 16 is activated to generate an alert (S11). Examples of an alert include, in addition to a buzzer sound, a display, light emission, vibrations, and communication to mobile terminals. The processing then returns to step S1 to repeat the processing.

Step S12 is then performed. In step S12, the criterion restorer 46a changes the allowable durations shortened in step S6 shown in FIG. 4 back to the initial values shown in FIG. 3, and returns the restored allowable durations to the criterion storage 56 (S12). The allowable durations that are not shortened through step S6 remain unchanged.

### Advantages and Effects

As described above, the distracted driving determination apparatus 20 according to the present embodiment performs distracted driving determination based on the allowable durations shown in FIG. 3 while the vehicle 1 is travelling straight. When the distracted driving determination apparatus 20 detects distracted driving, the distracted driving determination apparatus 20 alerts the driver by generating an alert from the alert device 16.

When the vehicle 1 changes the traveling direction by turning right or left, the allowable durations are shortened from, for example, the values in FIG. 3 to the values in FIG. 4. The distracted driving determination apparatus 20 thus alerts the driver 60 earlier when, for example, the driver is gazing in only one direction. Thus, the distracted driving determination apparatus 20 can prompt the driver 60 to thoroughly check the surroundings when changing the traveling direction of the vehicle 1.

### Second Embodiment

A distracted driving determination apparatus according to a second embodiment will now be described with reference to the drawings.

### Structure

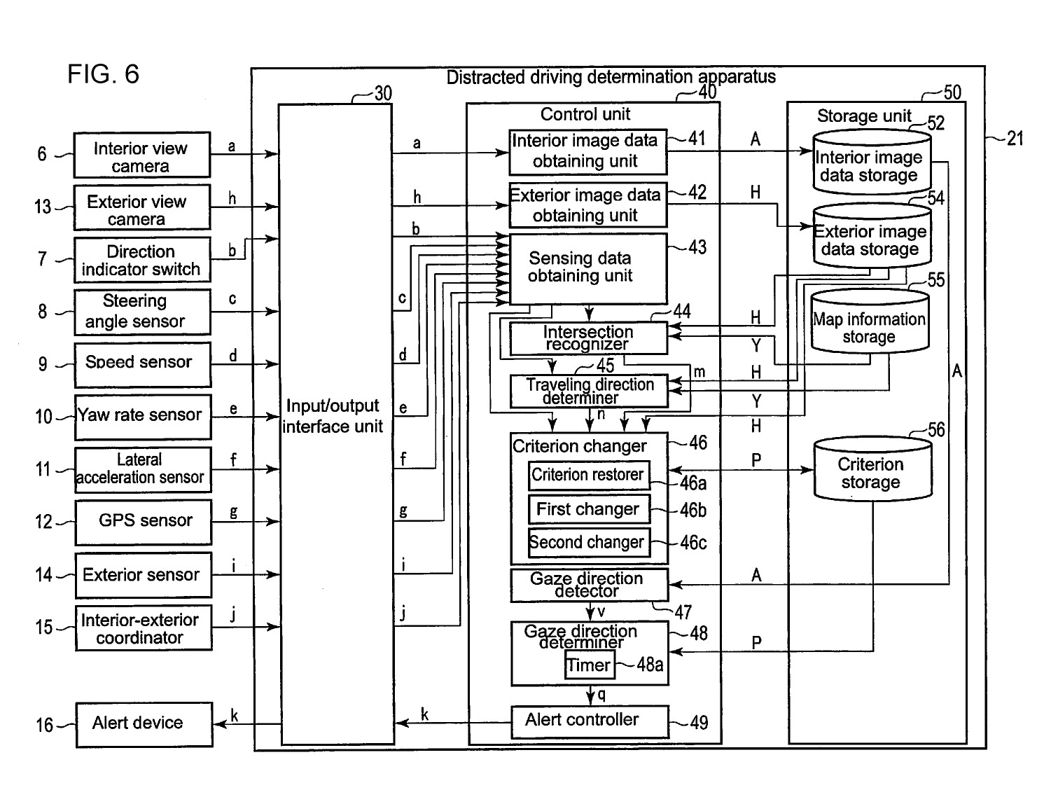

FIG. 6 is a functional block diagram of a distracted driving determination apparatus 21 according to the second embodiment.

The distracted driving determination apparatus 21 replaces the distracted driving determination apparatus 20 in FIG. 1. The distracted driving determination apparatus 21 is a modification of the distracted driving determination apparatus 20. The components of the distracted driving determination apparatus 21 different from the components of the distracted driving determination apparatus 20 will be described below, and the same components as the components of the distracted driving determination apparatus 20 are given the same reference numerals, and will not be described repeatedly.

As shown in FIGS. 6 and 2, the distracted driving determination apparatus 21 differs from the distracted driving determination apparatus 20 in that the criterion changer 46 is directly connected to the sensing data obtaining unit 43 and the exterior image data storage 54, and the criterion changer 46 further includes a first changer 46b and a second changer 46c.

The first changer 46b extends the allowable durations when the vehicle 1 is traveling at a speed lower than a predetermined speed and at a distance longer than a predetermined distance from a preceding vehicle traveling immediately ahead the vehicle 1 based on the sensing data from the sensing data obtaining unit 43.

More specifically, the first changer 46b determines the speed of the vehicle 1 based on the speed information D obtained from the detection signal d output from the sensing data obtaining unit 43. The first changer 46b also determines the distance between the vehicle 1 and the preceding vehicle based on the distance information I obtained from the sensing signal i output from the sensing data obtaining unit 43 or the image data H from the exterior image data storage 54.

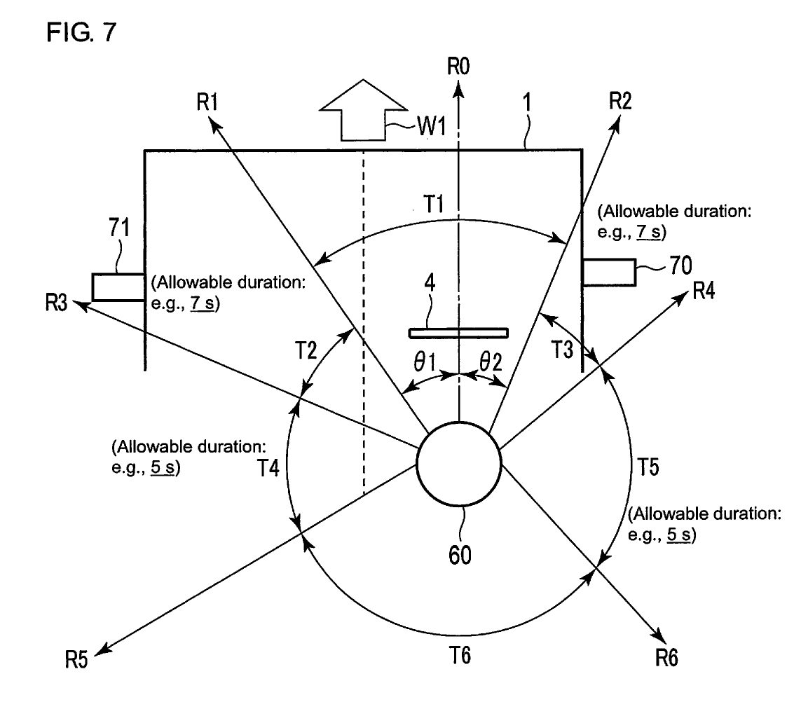

The first changer 46b extends the allowable durations when the vehicle 1 is traveling at a speed lower than a predetermined speed (e.g., 30 km per hour), and at a distance longer than a predetermined distance from the preceding vehicle. This will be described with reference to FIG. 7.

In the same manner as FIGS. 3 and 4, FIG. 7 is a schematic diagram of the vehicle interior of the vehicle 1 viewed from above.

In FIG. 7, the non-determinant areas T1 and T6 and the determinant areas T2 to T5 are defined similarly as in FIG. 3, whereas the allowable durations set for the determinant areas T2 to T5 are longer than the allowable durations set for the determinant areas T2 to T5 in FIG. 3. More specifically, the allowable durations are extended from five seconds to seven seconds for the determinant areas T2 and T3, and from three seconds to five seconds for the determinant areas T4 and T5. This equates to relaxing the criterion P to lower the likelihood that distracted driving is detected.

However, rather than relaxing the criterion P, the criterion P may be set stricter to increase the likelihood that distracted driving is detected when decelerating the vehicle 1 to below a predetermined speed to change the traveling direction by turning the vehicle 1 right or left, as described in the first embodiment.

In response to the intersection recognition signal m output from the intersection recognizer 44 and the detection signal n output from the traveling direction determiner 45, the criterion changer 46 shortens, as shown in FIG. 4, the allowable durations temporarily extended by the first changer 46b from the initial values shown in FIG. 3 in the same manner as when an intersection is recognized and a change is detected in the traveling direction. More specifically, the criterion changer 46 shortens the allowable durations as described in the first embodiment in response to a change detected in the traveling direction at an intersection although the vehicle 1 is traveling at a speed lower than a predetermined speed and at a distance longer than a predetermined distance from the preceding vehicle.

### Operation

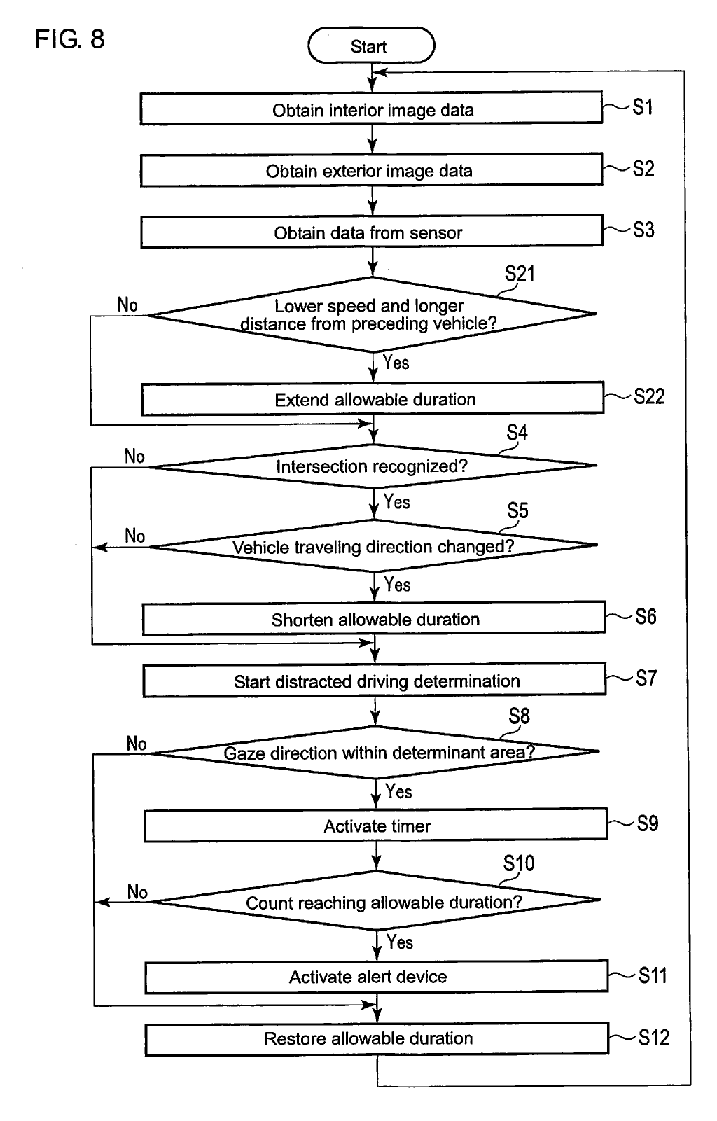

The operation of the distracted driving determination apparatus 21 with the above structure according to the present embodiment will now be described using the flowchart in FIG. 8.

The flowchart in FIG. 8 includes additional steps S21 and S22 between steps S3 and S4 in the flowchart in FIG. 5. Steps S1 to S12 are performed in the same manner as described above with reference to FIG. 5.

Thus, steps S21 and S22 will be described in detail below, whereas the steps that are the same as in FIG. 5 will not be described or described briefly.

In step S21 following step S3, the first changer 46b determines the speed of the vehicle 1 based on the speed information D from the sensing data obtaining unit 43. The first changer 46b also determines the distance between the vehicle 1 and the preceding vehicle based on the distance information I obtained from the sensing signal i output from the sensing data obtaining unit 43 and the image data H from the exterior image data storage 54.

When the speed of the vehicle 1 is determined to be lower than the predetermined speed and the distance between the vehicle 1 and the preceding vehicle is determined to be longer than the predetermined distance (Yes in S21), the first changer 46b relaxes the criterion P stored in the criterion storage 56. More specifically, the first changer 46b extends the allowable durations from the initial values shown in FIG. 3 to the values shown in FIG. 7 (S22). The processing then advances to step S4.

When the first changer 46b determines that the speed of the vehicle 1 is not lower than the predetermined speed, and/or when the distance between the vehicle 1 and the preceding vehicle is not longer than the predetermined distance (No in S21), the processing advances to step S4 without performing the processing in step S22.

The steps subsequent to step S4 are the same as those shown in FIG. 5. In response to a change detected in the traveling direction at an intersection (Yes in S4 and S5), the second changer 46c shortens the allowable durations extended in step S22 for the vehicle 1 traveling at a speed lower than the predetermined speed at a distance longer than the predetermined distance from the preceding vehicle (Yes in S21) from the allowable durations unchanged in step S22 or from the initial values.

When step S22 is skipped based on negative determination in step S21 (No in S21), the steps after step S4 are performed in the same manner basically as described in first embodiment, although the allowable durations are shortened by the second changer 46c in step S6.

### Advantages and Effects

As described above, the distracted driving determination apparatus 21 according to the present embodiment extends the allowable durations from the values in FIG. 3 to the values in FIG. 7 when the vehicle 1 decelerates below a predetermined speed and the distance between the vehicle 1 and the preceding vehicle is longer than a predetermined distance. The distracted driving determination apparatus 21 can thus determine distracted driving based on the criterion P appropriately set for the driving state of the vehicle 1.

Although the allowable durations are temporarily extended, the allowable durations are shortened from the initial values, or from the allowable durations that have yet to be extended, in response to a change detected in the traveling direction at an intersection. As in the first embodiment, the alert device 16 prompts the driver to thoroughly check the surroundings when the vehicle 1 changes the traveling direction by, for example, turning left or right.

Although the present invention has been described based on the specific embodiments with reference to the appended drawings, the present invention is not limited to the above embodiments. Variations and modifications will occur to those skilled in the art within the spirit and scope of the present invention defined by the claims. Such variations and modifications can fall within the technical scope of the present invention.

The present embodiment may be partially or entirely expressed in, but not limited to, the following forms shown in the appendix below in addition to the claims.

### Appendix 1

A distracted driving determination apparatus comprising a hardware processor,

the hardware processor being configured to

obtain sensing data from a sensor included in a vehicle;

detect a gaze direction of a driver of the vehicle based on the obtained sensing data;

determine distracted driving based on whether the detected gaze direction deviates by at least a predetermined angle from a traveling direction of the vehicle, and whether the deviation continues for at least a predetermined allowable duration allowing distracted driving;

output a signal instructing to generate an alert in response to detected distracted driving;

recognize an intersection in front of the vehicle in the traveling direction based on the obtained sensing data;

detect a change in the traveling direction of the vehicle based on the obtained sensing data; and

shorten the allowable duration in response to an intersection being recognized and a change detected in the traveling direction.

### Appendix 2

A distracted driving determination method performed by a distracted driving determination apparatus, the method comprising:

obtaining, with the distracted driving determination apparatus, sensing data from a sensor included in a vehicle;

detecting, with the distracted driving determination apparatus, a gaze direction of a driver of the vehicle based on the obtained sensing data;

detecting, with the distracted driving determination apparatus, distracted driving based on whether the detected gaze direction deviates by at least a predetermined angle from a traveling direction of the vehicle, and whether the deviation continues for at least a predetermined allowable duration allowing distracted driving;

outputting, with the distracted driving determination apparatus, a signal instructing to generate an alert in response to detected distracted driving;

recognizing, with the distracted driving determination apparatus, an intersection in front of the vehicle in the traveling direction based on the obtained sensing data;

detecting, with the distracted driving determination apparatus, a change in the traveling direction of the vehicle based on the obtained sensing data; and

shortening, with the distracted driving determination apparatus, the allowable duration in response to the intersection being recognized and the change detected in the traveling direction.

1. A distracted driving determination apparatus, comprising:
a data obtaining unit configured to obtain sensing data from a sensor included in a vehicle;
a gaze direction detector configured to detect a gaze direction of a driver of the vehicle based on the obtained sensing data;
a gaze direction determiner configured to determine distracted driving based on whether the detected gaze direction deviates by at least a predetermined angle from a traveling direction of the vehicle, and whether the deviation continues for at least a predetermined allowable duration allowing distracted driving;
an alert controller configured to output a signal instructing to generate an alert in response to distracted driving detected by the gaze direction determiner;
an intersection recognizer configured to recognize an intersection in front of the vehicle in the traveling direction based on the obtained sensing data;
a traveling direction determiner configured to detect a change in the traveling direction of the vehicle based on the obtained sensing data; and
a duration changer configured to shorten the allowable duration in response to an intersection being recognized and a change detected in the traveling direction.

2. The distracted driving determination apparatus according to claim 1, wherein
the duration changer includes
a first changer configured to change the allowable duration in accordance with a speed of the vehicle or a distance between the vehicle and a preceding vehicle determined using the obtained sensing data, and
a second changer configured to shorten, in response to an intersection being recognized and a change detected in the traveling direction, the allowable duration to a duration shorter than the allowable duration yet to be changed by the first changer.

3. The distracted driving determination apparatus according to claim 2, wherein
the first changer uses, as the sensing data, speed information from a speed sensor included in the vehicle, and image information about the preceding vehicle captured by an exterior view camera included in the vehicle, compares the speed of the vehicle determined from the speed information with a predetermined speed, and compares the distance between the vehicle and the preceding vehicle determined from the image information with a predetermined distance.

4. The distracted driving determination apparatus according to claim 1, wherein
the duration changer includes a restorer configured to change, in response to the intersection being no longer recognized or the change being no longer detected in the traveling direction, the shortened allowable duration back to the allowable duration yet to be shortened.

5. The distracted driving determination apparatus according to claim 1, wherein
the gaze direction deviating by at least the predetermined angle is within one of a plurality of determinant areas defined for detecting distracted driving, and
the allowable duration is separately set for each of the plurality of determinant areas.

6. The distracted driving determination apparatus according to claim 1, wherein
the intersection recognizer recognizes the intersection based on prestored map information in addition to the sensing data.

7. The distracted driving determination apparatus according to claim 1, wherein
the traveling direction determiner detects the change in the traveling direction based on prestored map information in addition to the sensing data.

8. The distracted driving determination apparatus according to claim 1, wherein
the traveling direction determiner detects the change in the traveling direction in response to detection of the vehicle entering a right-turn lane or a left-turn lane of a road based on prestored map information in addition to the sensing data.

9. A distracted driving determination method performed by a distracted driving determination apparatus, the method comprising:
obtaining, with the distracted driving determination apparatus, sensing data from a sensor included in a vehicle;
detecting, with the distracted driving determination apparatus, a gaze direction of a driver of the vehicle based on the obtained sensing data;
detecting, with the distracted driving determination apparatus, distracted driving based on whether the detected gaze direction deviates by at least a predetermined angle from a traveling direction of the vehicle, and the deviation continues for at least a predetermined allowable duration allowing distracted driving;
outputting, with the distracted driving determination apparatus, a signal instructing to generate an alert in response to detected distracted driving;
recognizing, with the distracted driving determination apparatus, an intersection in front of the vehicle in the traveling direction based on the obtained sensing data;
detecting, with the distracted driving determination apparatus, a change in the traveling direction of the vehicle based on the obtained sensing data; and
shortening, with the distracted driving determination apparatus, the allowable duration in response to the intersection being recognized and the change detected in the traveling direction.

10. A program for determining distracted driving, the program causing a computer to implement processes performed by the units included in the distracted driving determination apparatus according to claim 1.

11. A program for determining distracted driving, the program causing a computer to implement processes performed by the units included in the distracted driving determination apparatus according to claim 2.

12. A program for determining distracted driving, the program causing a computer to implement processes performed by the units included in the distracted driving determination apparatus according to claim 3.

13. A program for determining distracted driving, the program causing a computer to implement processes performed by the units included in the distracted driving determination apparatus according to claim 4.

14. A program for determining distracted driving, the program causing a computer to implement processes performed by the units included in the distracted driving determination apparatus according to claim 5.

15. A program for determining distracted driving, the program causing a computer to implement processes performed by the units included in the distracted driving determination apparatus according to claim 6.

16. A program for determining distracted driving, the program causing a computer to implement processes performed by the units included in the distracted driving determination apparatus according to claim 7.

17. A program for determining distracted driving, the program causing a computer to implement processes performed by the units included in the distracted driving determination apparatus according to claim 8.
